(19) United States
(12) Patent Application Publication
(10) Pub. No.: US 2011/0308139 A1
(43) Pub. Date: Dec. 22, 2011

(54) Pest eradication system

(75) Inventor: David James, Fort Collins, CO (US)

(73) Assignee: Nuvenco IP, LLC

(21) Appl. No.: 13/199,216

(22) Filed: Aug. 22, 2011

Related U.S. Application Data
(63) Continuation-in-part of application No. 12/998,620, filed on May 6, 2011.
Application No. 12/998,620 is a continuation-in-part of application No. 29/341,672, filed on Aug. 11, 2009, now Pat. No. D614725.
(60) Provisional application No. 61/154,759, filed on Feb. 23, 2009.

(51) Int. Cl. A01M 1/00

(52) U.S. Cl. 43/132.1

(57) ABSTRACT

Generally, a structure for eradication of insects and method of treating materials infested with insects. Specifically, a support structure which engages a flexible enclosure to define an enclosed space in which heat can be controlled over a period of time to eradicate insects inside of the enclosed space.

This application is a continuation-in-part of U.S. patent application Ser. No. 12/998,620, filed May 6, 2011, which is the United States National Stage of International Patent Cooperation Treaty Application No. PCT/US2010/000487, filed Feb. 19, 2010, which is a continuation-in-part of U.S. Design Patent Application No. 29/341,672, filed Aug. 11, 2009, now U.S. Pat. No. D614,725, issued Apr. 27, 2010, and claims the benefit of U.S. Provisional Patent Application No. 61/154,759, filed Feb. 23, 2009, each hereby incorporated by reference herein.

### I. FIELD OF THE INVENTION

Generally, a structure for eradication of insects and method of treating materials infested with insects. Specifically, a support structure which engages a flexible enclosure to define an enclosed space in which heat can be controlled over a period of time to eradicate insects inside of the enclosed space.

### II. BACKGROUND OF THE INVENTION

Insect damage is a common consumer problem related to clothing and other types of material. Insect damage to textiles in the United States is estimated at $200 million annually. Fabric pests are making a comeback because most of the residual insecticides formerly used in their control such as dieldrin and DDT have been banned. Accordingly, as people travel there is a growing incidence of insect infestation of garments transported in luggage. For example, bed bugs can be found in any hotel, motel, home, or other accommodation regardless of the sanitation conditions. During the day nocturnal insects disappear in crevices associated with mattresses, box springs, sheets, upholstery, garments, clothes, pillows, towels, or the like. Even when these materials are examined, it is common for these insects to be packed and transported in luggage.

Presently, conventional remedies appear to be limited to unpacking transported materials and examining them in a remote location such as the garage or utility room prior to introducing the transported materials into a residence area with treatment of infested materials by dry cleaning, fumigation, or the like, to kill infestations of insects.

### III. SUMMARY OF THE INVENTION

Accordingly, a broad object of the invention can be to provide a structure in which infested materials can be located for heat treatment at a temperature over a period of time lethal to the insects whether in the adult or other life stages prior to being transported from or into living areas of residences.

Another broad object of the invention can be to provide the structure in a constructional form which allows the collapse into a reduced volume for ready transportation as luggage or for storage in an remote location outside of the living area of hotel, motel, or other residence, the structure being readily erected to provide an operational volume in which materials can be located for heat treatment to kill insects.

Another broad object of the invention can be to provide the structure in a constructional form sufficiently large to hang materials such as garments on hangers for heat treatment at a temperature over a period of time lethal to insects whether in the adult or other life stages.

Another broad object of the invention can be to provide a structure in a constructional form in which the materials to be heat treated can be located within an enclosed space and the heater has a location outside of the enclosed space.

Another broad object of the invention can be to provide a structure in a constructional form that achieves a flow of heated air within an enclosed space at a flow rate sufficient to achieve a temperature over a period of time lethal to insects whether in the adult or other life stages.

Naturally, further objects of the invention are disclosed throughout other areas of the specification and drawings.

### IV. BRIEF DESCRIPTION OF THE DRAWINGS

FIG. 1 is a perspective view of a particular embodiment of the invention.

FIG. 2 is a top view of a particular embodiment of the invention.

FIG. 3 is an end view of a particular embodiment of the invention.

FIG. 4 is a side view of a particular embodiment of the invention.

FIG. 5 is a perspective view of a framework and heater having a location inside of a flexible enclosure (shown in broken line) of a particular embodiment of the invention.

FIG. 6 is a top view of a framework and heater having a location inside of a flexible enclosure (shown in broken line) of a particular embodiment of the invention.

FIG. 7 is a first end view of a framework and heater having a location inside of a flexible enclosure (shown in broken line) of a particular embodiment of the invention.

FIG. 8 is a side view of a framework and heater having a location inside of a flexible enclosure (shown in broken line) of a particular embodiment of the invention.

FIG. 9 is a second end view of a framework and heater having a location inside of a flexible enclosure (shown in broken line) of a particular embodiment of the invention.

FIG. 10 is a front view of an embodiment of the invention in the reduced volume condition.

FIG. 11 is a perspective view of a particular embodiment of the invention.

FIG. 12 is a front view of the particular embodiment of the invention.

FIG. 13 is end view of the particular embodiment of the invention.

FIG. 14 is a top view of the particular embodiment of the invention.

FIG. 15 is a partial cross section view of the particular embodiment the invention.

### V. DETAILED DESCRIPTION OF THE INVENTION

Generally, a structure for eradication of insects and method of treating materials infested with insects. Specifically, a support structure which engages a flexible enclosure to define an enclosed space in which heat can be controlled over a period of time to eradicate insects inside of the enclosed space.

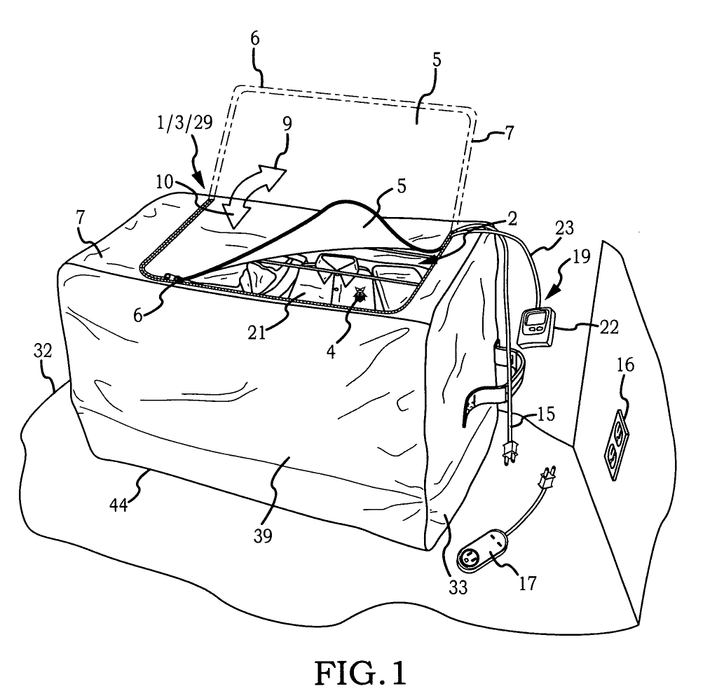

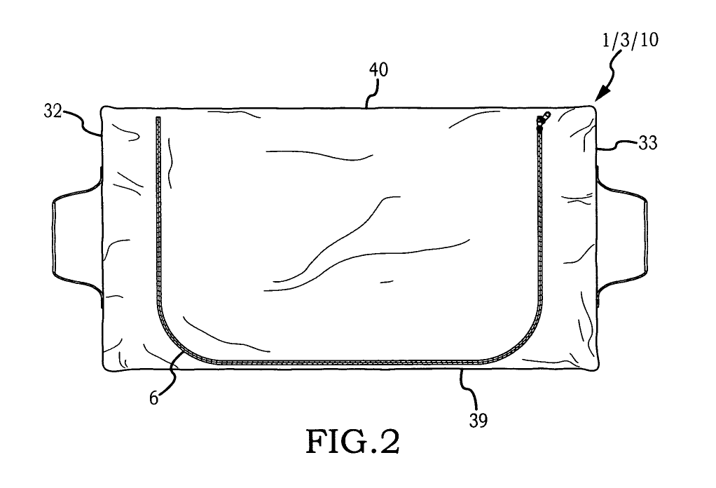

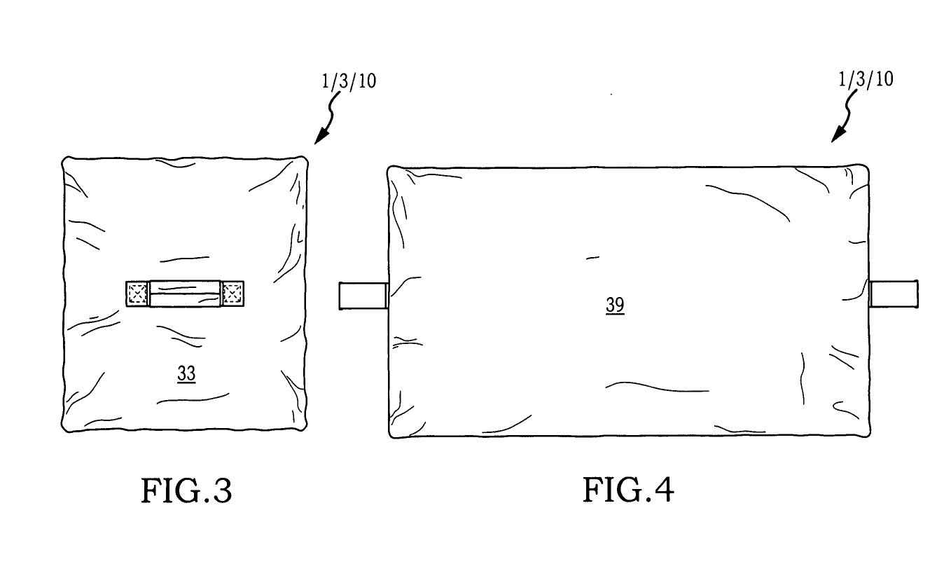

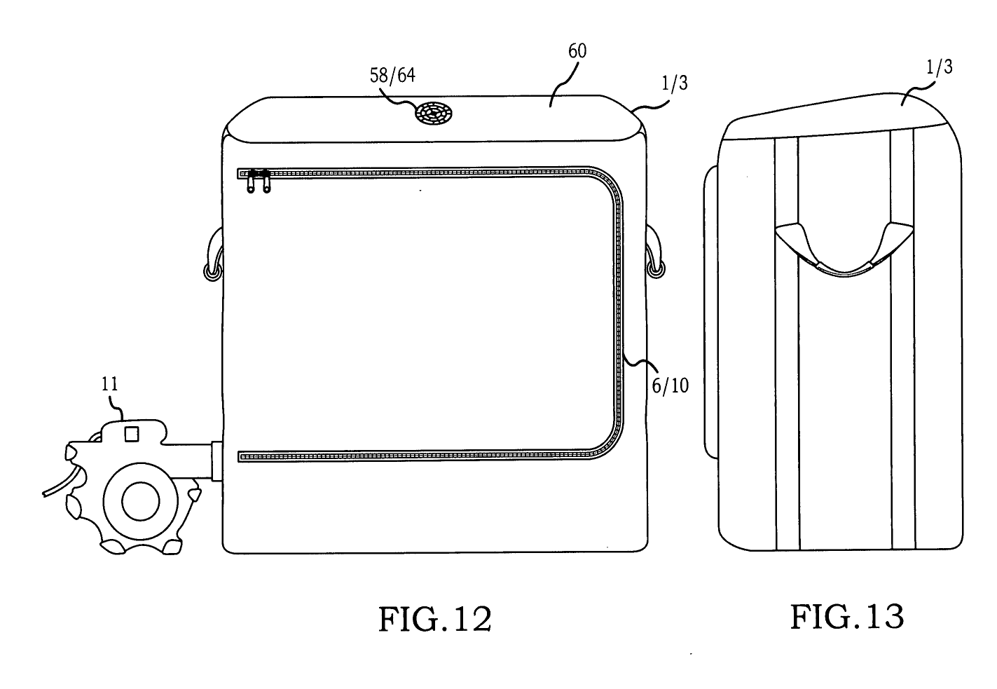

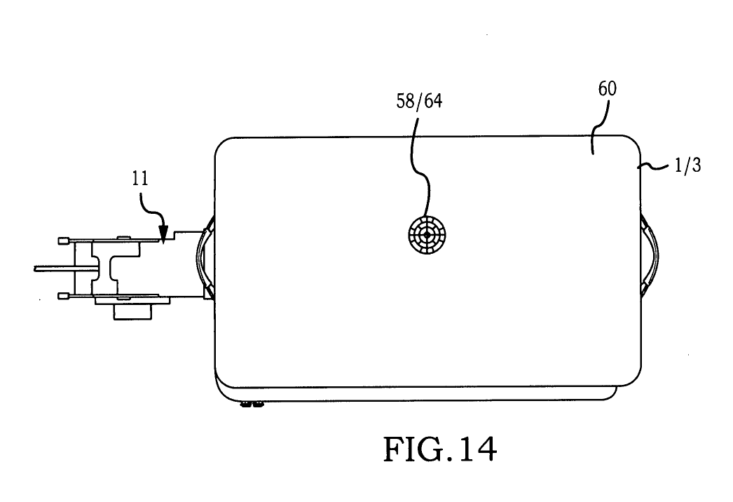

Referring primarily to FIGS. 1-4 and 11-14, embodiments of the invention provide a flexible enclosure (1). While the flexible enclosure (1) shown in FIGS. 1-4 and 11-14 has a generally rectangular external configuration and defines a generally rectangular enclosed space (2); the invention is not so limited and the flexible enclosure (1) can be configured to define an enclosed space (2) which can be tubular, a rectangular prism, a cube, pyramid, or the like.

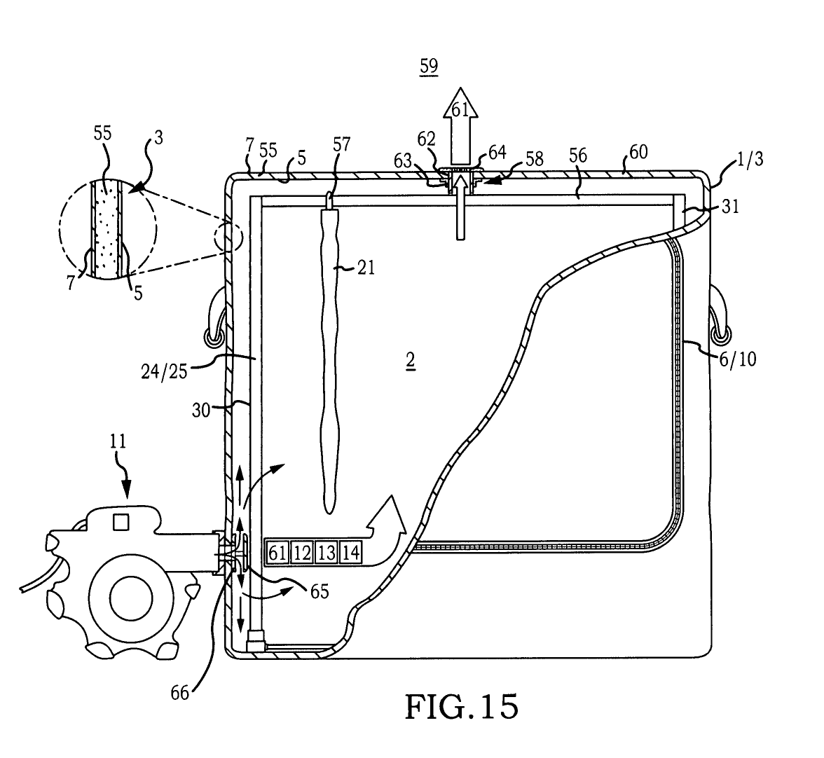

The flexible enclosure (1) can be produced from any one or more of a variety of flexible material(s) (3). The constructional form of the flexible material (3) can be a single layer, or two layers, or a plurality of layers which can be slidingly engaged or bonded together depending on the application. However, because insects (4) can readily travel on the surface of woven materials or on the surface of materials sufficiently textured or roughened, certain embodiments of the invention provide a flexible material (3) having a internal surface (5) sufficiently smooth to prevent, reduce, or impede travel of insects (4) to prevent egress through a releasably sealable opening (6) or other opening in the flexible enclosure (1). As one non-limiting example, the external surface (7) of the flexible enclosure (1) can provide a woven fabric of any of a numerous and wide variety of fibers such as cotton, nylon, rayon, polypropylene, polyester, carbon filaments, or the like, or combinations thereof. Because the external surface (7) of the flexible enclosure (1) does not come in contact with insects (4) placed within the enclosed space (2) of the flexible enclosure (1), any manner of external surface (7) texture can be utilized including a smooth external surface, if desired. The internal surface (5) of the flexible enclosure (1) can be provided by a plastic sheet or plastic film material such as polycarbonate, polyester, polyethylene, polyvinylchloride, or the like, further compatible with the method of using the flexible enclosure (1) for the eradication of insects (4), as further described below. As to certain non-limiting embodiments, as shown for example in FIG. 15, an insulation layer (55) (or a plurality of insulation layers) can be located between the external surface (7) and the internal surface (5) of the flexible enclosure (1). The insulation layer (55) can be provided by a numerous and wide variety of materials. As non-limiting examples, the insulation layer (55) can be provided by a layer of: polyester, polyethylene foam, VOLARA closed cell foam, MINICELL foam, neoprene foam, gymnastic rubber, or combinations a thereof.

Now referring primarily to FIGS. 1 and 2 and 11 and 12, the flexible enclosure (1) can further include a releasably sealable opening (6) which operates between an open condition (9) which allows access to the enclosed space (2) of the flexible enclosure (1) and a closed condition (10) in which the opening (6) seals by way of mateable parts such as the interdigitable teeth of a zipper as shown in FIGS. 1 and 2 and 11 and 12 or mateable engagement of a hook material to a loop material such as VELCRO; although the invention is not so limited, and any constructional form of mateable parts which sufficiently sealably mate to allow the enclosed space (2) of the flexible enclosure (1) to be temperature controlled, as further described below, may be utilized.

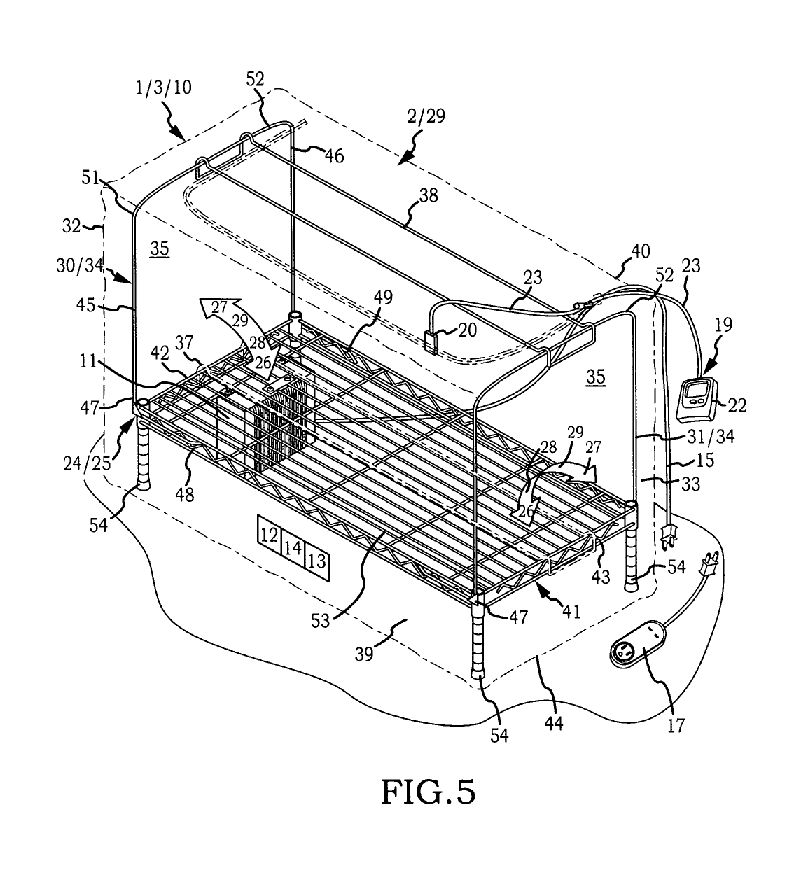

Now referring primarily to FIGS. 5-9 which show the flexible enclosure (1) in broken lines, particular non-limiting embodiments of the invention can further include a heater (11) which generates an amount of heat (12) captured within the enclosed space (2) of the flexible enclosure (1) to provide within the enclosed space (2) a temperature (14) over a period of time (13) lethal to a one or more species of insect (4). As a non-limiting example, the heater (11) can be selected to generate sufficient heat (12) to continuously maintain the temperature (14) within the enclosed space (2) of the flexible enclosure (2) in a range of between about 110° F. and about 160° F. for a period of time (13) between about five minutes and about 480 minutes.

With respect to the range of temperature (14), different species of insect (4) have different tolerance to heat (12) over a period of time (13). Accordingly, the heater (11) can be selected or controlled to produce the amount of heat (12) to maintain a temperature (14) over a period of time (13) lethal to the species of insect (4). Alternately, it is believed that no life stage of an insect (4) can survive at a temperature over about 130° F. for a period of 240 minutes. Accordingly, the heater (11) can be selected or controlled to produce an amount of heat (12) to raise the temperature within the enclosed space (2) of the flexible enclosure (1) to about 130° F. for a period of time (13) of 240 minutes. However, lesser temperature (14) of about 113° F. over a period of time (13) may be lethal to certain species of insects (4) such as bed bugs and greater temperatures of about 160° F. may reduce the period of time (13) to kill insects (4) within the enclosed space (2) of the flexible enclosure (1). Accordingly, embodiments of the invention can balance the temperature (14) achieved within the enclosed space (2) of the flexible enclosure (1) with the period of time (13) depending on the application, with embodiments of the invention represented by an increase in temperature (14) within the enclosed space (2) in increments of 2° F. over the temperature range of 110° F. and 160° F. and represented by an increase in the period of time (13) in increments of five minutes over the time period of five minutes and 480 minutes in the various permutations and combinations.

Temperature (14) and the period of time (13) can also be adjusted to allow the entirety of an amount of heat treatable material (21) having a location within the enclosed space (2) to achieve a temperature (14) lethal to insects (4), such insects (4) on or within heat treatable material (21) can be killed. As to the particular non-limiting embodiment of the invention shown in FIGS. 5-9, a 500 watt 120 volt heater (11) can be suitable to generate a sufficient amount of heat (12) to achieve temperatures (14) over a period of time (13) within the enclosed space (2), as above-described, sufficient to kill insects (4) inside of the flexible enclosure (1).

Accordingly, embodiments of the invention can provide a temperature (14) within the flexible enclosure (2) within one or more of the temperature ranges selected from the group including or consisting of: about 110° F. and about 120° F., about 115° F. and about 125° F., about 120° F. and about 130° F., about 125° F. and about 135 ° F., about 130° F. and about 140° F., about 135° F. and about 145° F., about 140° F. and about 150° F., about 145 ° F. and about 155° F., about 150° F. and about 160° F., about 155° F. and about 165° F., about 160 ° F. and about 170° F., about 165° F. and about 175° F., about 170° F. and about 180° F., about 175 ° F. and about 185° F., and about 180° F. and about 190° F.

Additionally, embodiments of the invention can provide a period of time (13) within one or more of the ranges of time selected from the group including or consisting of: about 5 minutes and about 30 minutes, about 15 minutes and about 45 minutes, about 30 minutes and about 60 minutes, about 45 minutes and 75 minutes, about 60 minutes and about 90 minutes, about 75 minutes and about 105 minutes, about 90 minutes and about 120 minutes, about 105 minutes and about 135 minutes, about 120 minutes and about 150 minutes, about 135 minutes and about 165 minutes, about 150 minutes and about 180, about 165 minutes and about 195 minutes, about 180 minutes and about 210 minutes, about 195 minutes and about 225 minutes, about 210 minutes and about 240 minutes, about 225 minutes and about 255 minutes, about 240 minutes and about 270 minutes, about 255 minutes and about 285 minutes, about 270 minutes and about 300 minutes, about 285 minutes and about 315 minutes, about 300 minute and about 330 minutes, about 315 minutes and about 345 minutes, about 330 minutes and about 360 minutes, about 345 minutes and about 375 minutes, about 360 minutes and about 390 minutes, about 375 minutes and about 405 minutes, about 390 minutes and about 420 minutes, about 405 minutes and about 435 minutes, about 420 minutes and about 450 minutes, about 435 minutes and about 465 minutes, and about 450 minutes and about 480 minutes.

Now referring primarily in FIGS. 1 and 5, embodiments of the invention in which the heater (11) has a location within the enclosed space (2) of the flexible enclosure (1), a power cord (15) for the heater (11) can pass through a part of the releasably sealable opening (6) for coupling to a power source (16).

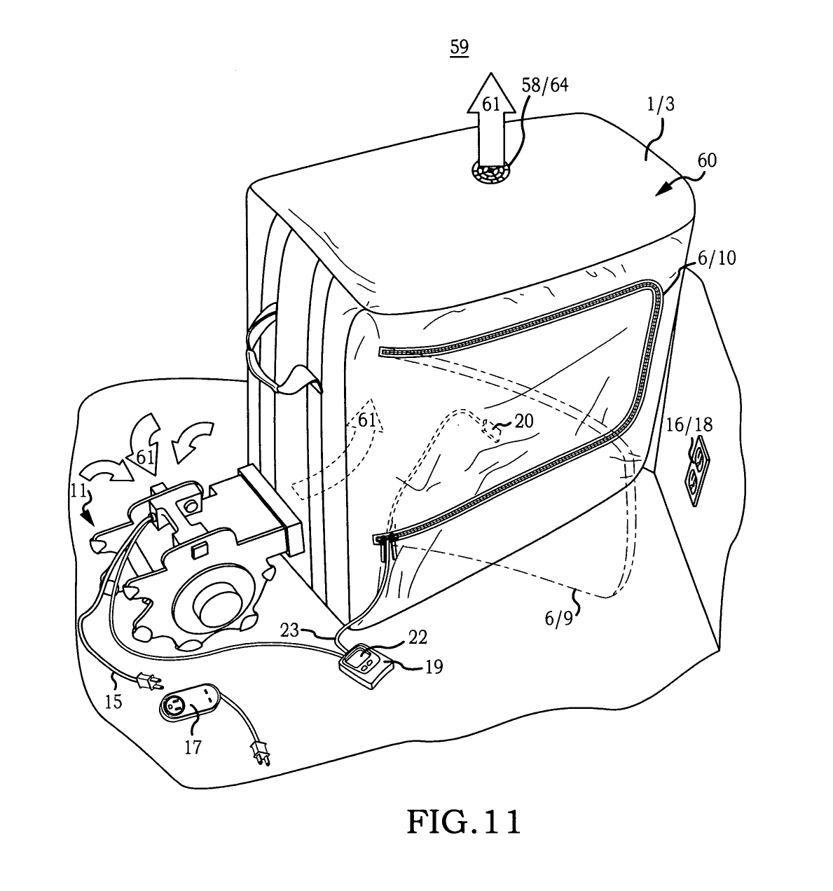

Now referring primarily to FIGS. 11-15, particular non-limiting embodiments of the invention, can provide a heater (11) which generates the amount of heat (12) captured within the enclosed space (2) of the flexible enclosure (1) having a location outside of the flexible enclosure (1) with the heat (12) generated by the heater (11) conveyed from outside of the flexible enclosure (1) to within the enclosed space (2) of the flexible enclosure (1) by direct engagement of the heater (11) to the external surface (7) of the flexible enclosure (1). As to the particular embodiments of the invention shown in FIGS. 11-15, a non-limiting example of a heater (11) suitable for use with embodiments of the invention can be an AMSTAR Portable Fan, 300 CFM (PN AMS5000) coupled to a AMSTAR Heater Attachment, 120 volt, 60 Hz, 12 amps, 1320 watt, 4,500 BTU/hour (PN AMS5001), each available from AmStar Tools and Equipment, New York, which can generate a sufficient amount of heat (12) to achieve temperatures (14) over a period of time (13) within the enclosed space (2), as above-described, sufficient to kill insects (4) inside of the flexible enclosure (1).

However, the above examples are not intended to be limiting but rather illustrative of the numerous and varied heaters (11) that can be utilized to deliver heat (12) to the enclosed space (2) of the flexible enclosure (1). Other types of heaters (11) can have embedded engagement between layers of the flexible material (3), or by a conduit fluidicly couples the heater (11) and the enclosed space (2) of the flexible enclosure (1), or the like.

Again referring primarily to FIGS. 1, 5 and 11, embodiments of the invention can further include a timer (17) which electrically couples the heater (11) to the power source (16) for a period of time (13) in the range above described. Depending on the application, the period of time (13) can be selectably adjusted by use of the timer (17) to deliver power (18) from the power source (16) for a period of time between 5 minutes and 120 minutes (or longer if desired, for example 8 hours). As a non-limiting example, the timer (17) can be selectably adjusted to deliver power (18) to the heater (11) for a period of time (13) of 120 minutes. A timer (17) suitable for use with particular embodiments of the invention can be a digital timer (17) obtained from Best Corporation, Fort Wayne, Ind.

Again referring primarily to FIGS. 1, 5, and 11, embodiments of the invention can further include a thermometer (19) having temperature sensor (20) which can be located within the enclosed space (2)(or within an amount of heat treatable material (21) located within the enclosed space (2)) of the flexible enclosure (I) and a viewable temperature indicator (22) which can be located outside of the flexible enclosure (1). As shown in FIG. 1, the temperature sensor (20) can be coupled to the viewable temperature indicator (22) by a sensor wire (23) which can pass through a part of the releasably sealable opening (6) (or other aperture communicating between internal surface (5) of the flexible material (3) and the external surface (7) of the flexible material (3)) in the closed condition (10). A thermometer (19) suitable for use with embodiments of the invention can be a model TX 5020 available from Timex, Edison, N.J.

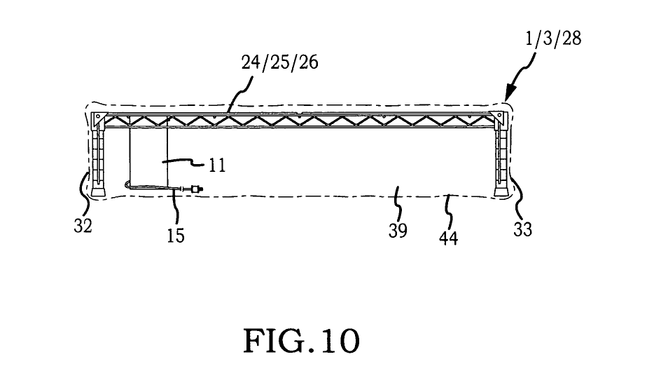

Now referring primarily to FIGS. 5-9, particular embodiments of the invention can further provide a framework (24) which supports the flexible material (3) of flexible enclosure (1) to define the enclosed space (2) within the flexible enclosure (1). As to certain embodiments of the invention, the framework (24) can be provide a fixed support structure (25) (does not collapse), while as to other embodiments of the invention, the framework can provide a collapsible support structure (25) which operates between a collapsed condition (26) (see for example FIG. 10) and an erect condition (27) (see for example FIG. 5) to correspondingly provide a reduced volume (28) (see for example FIG. 10) and an operational volume (29) (see for example FIG. 1) of the flexible enclosure (1).

Now referring primarily to FIGS. 5-9, particular embodiments of the framework (24) can provide a fixed support structure (25) having a first end frame (30) and second end frame (31) configured to supportingly engage and define the configuration of an opposed first end (32) and second end (33) of the flexible enclosure (1). The first and second end frames (30)(31) can for example be configured from metal rod (for example, between one-eighth inch diameter and one-quarter inch diameter) which can be bent to provide a wire end frame (34) defining within an open area (35) as shown for example in FIG. 5. The first and second end frames (30) can be held a distance apart by corresponding side frames (36)(37) or a top frame (38) which supportingly engage and define the configuration of the opposed first and second sides (39)(40) of the flexible enclosure (1). The first and second side frames (36)(37) can be similarly constructed from metal rod bent to provide a wire frames (34) defining within an open area (35)

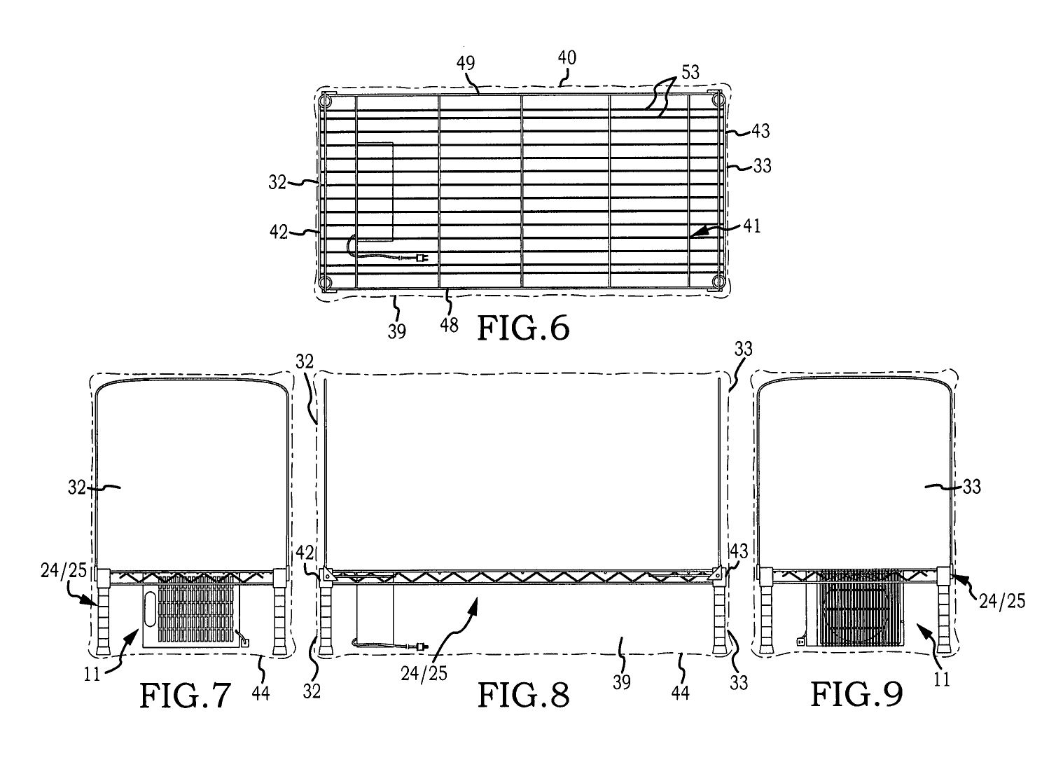

Alternately, as shown in FIGS. 5-9, fixed embodiments of the invention can provide a support structure (25) including a perforated platform (41) (although the perforated platform (41) can be provided separate from the support structure) to which the first and second end frames (30)(31) can be joined proximate opposed platform ends (42)(43). As shown for example in FIG. 5, the perforated platform (41) can be generally rectangular in configuration and located within the enclosed space (2) of the flexible enclosure (1) in generally horizontal relation to the bottom (44) of the flexible enclosure (1). The first and second end frames (30)(31) can each comprise a wire frame (34) having a pair of generally linear members (45)(46) each having a first member end (47) fixedly coupled to opposed platform sides (48)(49) proximate the end (42)(43) of the perforated platform (41) and a second member end (51)(see FIG. 5) correspondingly connected to opposed ends of a cross member (52). The first and second end frames (30)(31) coupled to the perforated platform (41) can supportingly engage the flexible enclosure (1) to provide an operational volume (29) of generally rectangular volume. While FIGS. 5 and 6 show the perforated platform (41) as being assembled from a plurality of metal rods (53) each spaced a distance apart between the opposed sides (48)(49) of the perforated platform (41); the invention is not so limited, and the perforated platform (41) can be produced from pressed sheet material having a plurality of perforations or slots communicating between the surfaces of the sheet material for the purpose of allowing the heat (12) to circulate through the perforations, slots, or spaces of the perforated platform (41). As to certain embodiments of the invention the perforated platform (41) can be located a distance from the bottom (44) of the flexible enclosure (2) by one or more vertical support members or legs (54). As shown in non-limiting example of FIG. 5, the perforated platform (41) is located at a height above the bottom (44) of the flexible enclosure (2) by a generally vertical support member (54) proximate each corner of the perforated platform (41). Understandably, as to certain embodiments of the invention the platforms without perforations can be utilized.

Certain embodiments of the invention can provide a collapsible support structure (25) which operates between a collapsed condition (26) and an erect condition (27). One non-limiting example of a collapsible support frame (25) is shown by FIG. 5, which includes the above described first and second end frames (30)(31) each including a pair of substantially linear members (45)(46) each having the first end (47) rotatably coupled to opposed platform sides (48)(49) proximate an end (42)(43) of said perforated platform (41) and each having a second end (51) correspondingly connected to opposed ends of a cross member (52). Each of the first and second end frames (30)(31) can rotate between a collapsed condition (26) having generally horizontal orientation in relation to the bottom (44) and an erect condition (27) generally vertical in orientation to the bottom (44) to correspondingly provide the reduced volume (28) and operation volume (29) of the flexible enclosure (2). Understandably, other configurations of a collapsible support structure (25) can be utilized to engage the flexible material (3) to provide a flexible enclosure (2) having a reduced volume (28) and an operational volume (29).

Now referring primarily to FIGS. 11 through 15, particular embodiments of the invention can provide a framework (24) with a first end frame (30) and a second end frame (31) each having sufficient dimensional relations to allow a cross member (56) to be coupled between from which heat treatable material (21), such as garments, shirts, pants, or like, can hung from one or more hangers (57). A non-limiting example of a framework suitable for use with embodiments of the invention can be a Style # 6021-196 available from Whitmore, Inc., 8680 Swinnea Road, Suite 103, Southhaven, Miss. 38671.

While the embodiments of the invention shown in FIGS. 5-9 and 11-15 show the framework (24) located within the flexible enclosure (1), the invention is not so limited, and embodiments of the invention can provide the framework (24) supportingly engaged to the external surface (7) of the flexible enclosure (1) or disposed between the layers of the flexible material (3).

Now referring primarily to FIGS. 11 through 15, particular embodiments of the invention can further provide a vent element (58) which fluidicly couples the enclosed space (2) to atmosphere (59). As shown in the non-limiting example of FIG. 11, the vent element (58) can be located on the top (60) of the flexible enclosure (1); however, the invention is not so limited; and the vent element (60) can be located at any location through which air flow (61) can pass generally unobstructed from within the enclosed space (2) to atmosphere (59) external to the flexible enclosure (1). As to certain embodiments, the vent element (58) can take the form of one or more aperture element(s)(62) which perforate the flexible material (3) to provide one or more passages through which airflow (61) can pass. While there is no preferred configuration of the aperture element (62), the aperture element (62) can have a generally circular configuration. As to other embodiments, as shown in the non-limiting example of FIG. 11, the vent element (58) can take the constructional form of a conduit (63) which can be coupled within an aperture element (62) which perforates the flexible material (3). The conduit (63) can have a tubular form providing a passage through which air flow (61) from within the enclosed space (2) can pass to atmosphere (59). A screen element (64) can be coupled at one or both ends of the conduit (63) to prevent ingress or egress of objects having dimensions greater than the mesh size of the screen element (64) through the conduit (63). Generally, the mesh size will be between 16 mesh and 5 mesh market grade; however, the invention is not so limited. A non-limiting example of a vent element (58) suitable for use with embodiments of the invention can be a floor drain one and one half inch high by 3 inch diameter obtained from Sioux Chief Manufacturing, Peculiar, Mo.

The vent element(s) (62) function in the first instance to adjust the amount of air flow (61) through the enclosed space (2). Certain embodiments of the flexible enclosure (1) without the vent element(s) (62) can achieve sufficient air flow (61) through seams, releasably sealable openings, closure elements, or the like. However, other embodiments which lack the vent element(s) (62), can have a reduced air flow (61) through the enclosed space (2). An insufficient air flow (61) through the enclosed space (2) can reduce the amount of heat (12) introduced into the enclosed space (2) and can prevent obtention or maintenance of a temperature (14) within the enclosed space (2) of the flexible enclosure (2) sufficient to kill insects, can fall continuously or periodically outside of a range of between about 110° F. and about 160° F. Additionally, an insufficient airflow (61) through the enclosed space (2) can increase the period of time (13) for treatment of heat treatable material to kill insects (4). In the second instance, an insufficient air flow (61) through the enclosed space (2) can result in an insufficient air flow (61) through the heater (11). As a result, the heater (11) may overheat.

Now referring primarily to FIG. 15, embodiments can further include a deflector (65) coupled proximate the inlet (66) of air flow (61) from the heater (11). The deflector serves to disseminate the air flow (61) within the enclosed space (2) and also acts to prevent heat treatable materials (21) or other materials from blocking ingress of the air flow (61) through the heater inlet (66).

Now referring primarily to FIGS. 1 and 11, embodiments of the invention can further include an amount heat treatable material (21). For the purposes of this invention the term “heat treatable material” can be any material which can be removably located inside of the flexible enclosure (2) in the operational volume (29) and heated to a temperature (14) for a period of time (13) sufficient to kill insects (4). As a non-limiting example, within the temperature (14) range of about 110° F. and about 160° F. within a period of time of about 5 minutes and about 480 minutes, a further described above. Heat treatable material (21) can further include material having attached, containing, or infested with, insects (4) regardless of the life stage.

Now referring primarily to FIGS. 1-4 which show the operational volume (29) of a particular embodiment of the flexible enclosure (1). The flexible enclosure (1) in the operational volume (29) and in the reduced volume (28) (see for example, FIG. 10) can have external dimensions compatible with carrying the structure for killing insects (4) by hand. An advantage of the structure for killing insects (4) can be portability which allows the structure for killing insects (4) to be transported in similar fashion to luggage for utilization while traveling to kill insects such as bed bugs in a hotel or motel room or other similar accommodation preventing transport of insects (4) from location to location.

For the purposes of this invention, the term “insect” includes all insects and without limitation to the forgoing insects such as bed bugs, powder post beetles, moths, roaches, termites, fleas, wasps, bees, cicadas, ants, lice, head lice, mites, grain beetles, flour beetles, fire ants, mosquitoes, leafhoppers, plant hoppers, ticks, flies, or the like, and can further include non-insect species such as spiders, ticks, centipedes, or the like, and including the adult form or any other form of the insect including but not limited to: eggs, larvae, pupae, cocoons, chrysalides, or any other life stage or life form of an insect, and can further include other pest organisms as to which the temperature and time periods described herein would be lethal.

A non-limiting example of a method of using embodiments of the structure for killing insects can include a step of providing a flexible enclosure (1) having a releasably sealable opening (6) which operates between an open condition (9) and a closed condition (10), the flexible enclosure (1) having an external surface (7) and an internal surface (5), the internal surface (5) sufficiently smooth to prevent egress of said insects (4) through said releasably sealable opening (6). Another step of the method includes coupling a heater (11) to the flexible enclosure (1), the heater (11) capable of generating an amount of heat (12) within said flexible enclosure (1) to provide a temperature (14) over a period of time (13) lethal to insects (4). The method includes the further step of locating heat treatable materials (21) which may be infested with insects (4) within the enclosed space (inside) of the flexible enclosure (1). The method can further include the steps of establishing the releasably sealable opening (6) in the closed condition (10), and operating the heater (11) to achieve a temperature (14) over a period of time (13) inside of the flexible enclosure (1) lethal to said insects (4). The method can further include the step of establishing said temperature within said flexible enclosure within a range of about 110° F. and about 160° F. and can further include the step of allowing elapse of a period of time (13) within a range of about 5 minutes and about 480 minutes to treat heat treatable material within the enclosed space (2) of the flexible enclosure (1). The method can further include the steps of sensing temperature inside of the flexible enclosure (1) and indicating the temperature (13) on a temperature indicator (22) located outside of the flexible enclosure (1) which validates that the enclosed space (2) within the flexible enclosure (1) (or the heat treatable material (21) located within enclosed space (2)) has achieved a temperature (13) lethal to insects (4).

As to certain embodiments of the invention, the method can further include the steps of operating an enclosure support structure (25) between a collapsed condition (26) and an erect condition (27) to correspondingly provide a reduced volume (28) and operational volume (29) of the flexible enclosure (1). The method can further include the steps of providing a perforated platform (41) having proximate opposed ends (42)(43) a pair of substantially linear members (45)(46) each having a first end (47) rotatably coupled to opposed sides (48)(49) of the perforated shelf (41) and each having second end (51) correspondingly connected to opposed ends of a cross member (52) to provide the enclosure support structure (25). The method can further include the steps of configuring the perforated platform (41) in substantially rectangular configuration and locating the substantially rectangular configuration of the perforated platform (41) inside of the flexible enclosure (1) in generally horizontal relation to the bottom side (44) of the flexible enclosure (1) and configuring the first and second end frames (30)(31) of the enclosure support (25) in a substantially rectangular configuration which in the erect condition (27) locates inside of the flexible enclosure (1) in substantially vertical relation to the bottom (44) of the flexible enclosure (1) to define a generally rectangular operational volume (29) of the flexible enclosure (1).

Now referring primarily to FIG. 10, as to certain embodiments of the invention, the method can further include the step of providing the reduced volume (28) of said flexible enclosure (1) in dimensional relations which allows a person to carry the flexible enclosure (1). As a non-limiting example, the flexible enclosure (1) in the operational volume (29) can have external dimensions of about 40 inches in length and about 18 inches in width with a height of about 24 inches and in the reduced volume (28) can have external dimensions of about 40 inches in length and about 18 inches in width and about 10 inches in height; however, the invention is not so limited and depending upon the embodiment of the collapsible support structure (25) the external dimensions could be further reduced to facilitate portability or carrying by a single person.

Now referring primarily to FIGS. 11-15, as to certain embodiments of the invention, the method can further include the steps of locating the heater (11) outside of the flexible enclosure (2) and fluidicly coupling the heater (11) to the enclosed space (2) within the flexible enclosure (2). The method can further include the step of venting the enclosed space (2) and establishing sufficient air flow (61) through the enclosed space (2) to prevent overheating of the heater (11) and to establish sufficient temperature (14) within the enclosed space (2) to kill insects.

Now referring primarily to Table 1, which compares temperature (14) over period of time (13) inside the enclosed space (2) of a particular embodiment of the inventive pest eradication device shown in FIGS. 11-15 and above described utilized to kill bed bugs. The pest eradication device was established in the closed condition (10) with the temperature sensor (20) located in the enclosed space distal from ingress of the airflow (61) from the external heater (11). No heat treatable material (21) was located inside the enclosed space (2). The external heater (11) was made operational and the temperature (14) inside the enclosed space (2) was observed on the viewable temperature indicator (22) and recorded after elapse of several consecutive periods of time (13).

TABLE 1
Pest Eradication Device-- Trial Without Heat Treatable Materials.

| | Elapsed Time Minutes | | | | | | | |
|---|---|---|---|---|---|---|---|---|
| | 0 | 3 | 6 | 8 | 13 | 14 | 17 | 16 |
| Temperature | | 94 | 104 | 113 | 120 | 120 | 124 | 129 |
| F.° - Sensor 1 | | | | | | | | |

As can be understood from Table 1, the temperature (14) within the enclosed space rose from ambient temperature to a temperature (14) (113° F.)lethal to bed bugs in less than 15 minutes and continuously maintained or exceeded that temperature (14) thereafter.

Now referring primarily to Table 2, which compares temperature (14) over period of time (13) inside the enclosed space (2) of a particular embodiment of the inventive pest eradication device shown in FIGS. 11-15 and above described utilized to kill bed bugs. The pest eradication device was established in the open condition (9) and heat treatable material was hung on a framework (24) inside the pest eradication device. The pest eradication device was then established in the closed condition (10) with two temperature sensors (20) located in the enclosed space (2): one proximate the center of the enclosed space (Sensor 1) and one distal from ingress of the airflow (61) from the external heater (11) (Sensor 2). The external heater (11) was made operational and the temperature (14) inside the enclosed space (2) was observed on the viewable temperature indicator (22) and recorded after elapse of several consecutive periods of time (13).

TABLE 2
Pest Eradication Device-- Trial With Heat Treatable Materials.

| Elapsed Time | | | | | |
|---|---|---|---|---|---|
| Minutes | 0 | 15 | 45 | 60 | 85 |
| Temperature | | 90 | 109 | 113 | 120 |
| F. °- Sensor 1 | | | | | |
| Temperature | | 91 | 110 | 117.9 | 121.6 |
| F. °- Sensor 2 | | | | | |

As can be understood from Table 2, the temperature (14) within the enclosed space rose from ambient temperature to a temperature (14) (113° F.) lethal to bed bugs in about sixty minutes and continuously maintained or exceeded that temperature (14) thereafter. The rise in temperature (14) was generally uniform throughout the enclosed space (2) even with heat treatable material (21) hanging inside of the enclosed space (2).

Now referring primarily to Table 3, which compares temperature (14) over period of time (13) inside the enclosed space (2) of a particular embodiment of the inventive pest eradication device shown in FIGS. 11-15 and above described utilized to kill bed bugs. The pest eradication device was established in the open condition (9). Heat treatable material (21) (such as shirts, pillows, and blankets) were transferred to a flexible plastic container (similar to a conventional plastic garbage bag). The plastic container containing heat treatable material (21) was located inside the pest eradication device. The pest eradication device was then established in the closed condition (10) with three temperature sensors (20) located in the enclosed space (2): one proximate the center of the heat treatable material inside of the plastic bag (Sensor 1), one proximate the center of the enclosed space (Sensor 3), and one distal from ingress of the airflow (61) from the external heater (11) (Sensor 2). The external heater (11) was made operational and the temperature (14) inside the enclosed space (2) was observed on the viewable temperature indicators (22) and recorded after elapse of several consecutive periods of time (13).

TABLE 3
Pest Eradication Device-- Trial With Heat Treatable Materials.

| Elapsed Time | | | | | | |
|---|---|---|---|---|---|---|
| Minutes | 0 | 40 | 60 | 80 | 120 | 240 |
| Temperature | | 74 | 81 | 86 | 99 | 121 |
| F. °- Sensor 1 | | | | | | |
| Temperature | | 83 | 93 | 98 | 108 | 127 |
| F. °- Sensor 2 | | | | | | |
| Temperature | | 91 | 101 | 106 | 116 | 130 |
| F. °- Sensor 3 | | | | | | |

As can be understood from Table 3, the temperature (14) within the enclosed space (2) rose from ambient temperature to a temperature (14) (113° F.)lethal to bed bugs in about 120 minutes while the temperature generally central to the heat treatable material (21) inside of the flexible plastic container rose from ambient temperature to a temperature (14) lethal to bed bugs in about 240 minutes and continuously maintained or exceeded that temperature (14) thereafter. The rise in temperature (14) was non-uniform with respect to the heat treatable material (21) within the flexible plastic container as compared to the remaining volume of the enclosed space (2). However, the heat treatable material (21) even when enclosed within a flexible plastic container within the enclosed space (2) of the pest eradication device can achieve sufficient temperature (14) to kill bed bugs and other insects.

As can be easily understood from the foregoing, the basic concepts of the present invention may be embodied in a variety of ways. The invention involves numerous and varied embodiments of a insect eradication structure and methods of treating materials infested with insects.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “flexible enclosure” should be understood to encompass disclosure of the act of “flexibly enclosing”—whether explicitly discussed or not—and, conversely, were there effectively disclosure of the act of “flexibly enclosing”, such a disclosure should be understood to encompass disclosure of a “flexible enclosure” and even a “means for flexibly enclosing.” Such alternative terms for each element or step are to be understood to be explicitly included in the description.

All numeric values herein are assumed to be modified by the term “about”, whether or not explicitly indicated. For the purposes of the present invention, ranges may be expressed herein as from “about” one particular value to “about” another particular value. When such a range is expressed, another embodiment includes from the one particular value to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. Unless otherwise expressly stated, embodiments of the invention represented by increase or a decrease in the numeric value from an end point or both end points within a range in increments of five percent.

Moreover, for the purposes of the present invention, the term “a” or “an” entity refers to one or more of that entity; for example, “a flexible enclosure” refers to one or more of those enclosures. As such, the terms “a” or “an”, “one or more” and “at least one” can be used interchangeably herein.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

Thus, the applicant(s) should be understood to claim at least: i) each of the insect eradication structures herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States or foreign patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

The claims set forth below are intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A structure for killing insects, comprising:
a) a flexible enclosure having a releasably sealable opening which operates between an open condition and a closed condition, said flexible enclosure in said closed condition defining an enclosed space; and
b) a heater having a location external of said flexible enclosure, said heater generating an airflow fluidicly coupled to said enclosed space of said flexible enclosure, said air flow providing an amount of heat inside said flexible enclosure sufficient to achieve a temperature over a period of time lethal to said insects.

2. The structure for killing insects of claim 1, further comprising a vent element coupled to said flexible enclosure which allows egress of said air flow from said enclosed space, said vent having dimensional relations which allows egress of said air flow from within said enclosed space at an air flow rate sufficient to provide said amount of heat inside said flexible enclosure to achieve said temperature over said period of time lethal to said insects

3. The structure for killing insects of claim 2, wherein said temperature within said flexible enclosure occurs within a range of about 110° F. and about 160° F.

4. The structure for killing insects of claim 3, wherein said temperature within said flexible enclosure is selected from the group consisting of: about 110° F. and about 120° F., about 115° F. and about 125° F., about 120° F. and about 130° F., about 125° F. and about 135° F., about 130° F. and about 140° F., about 135° F. and about 145° F., about 140° F. and about 150° F., about 145° F. and about 155° F., about 150° F. and about 160° F., about 155° F. and about 165° F., about 160° F. and about 170° F., about 165° F. and about 175° F., about 170° F. and about 180° F., about 175° F. and about 185° F., and about 180° F. and about 190° F.

5. The structure for killing insects of claim 3, wherein said period of time occurs within a range of about 5 minutes and about 480 minutes.

6. The structure for killing insects of claim 5, wherein said period of time is selected from the group consisting of: about 5 minutes and about 30 minutes, about 15 minutes and about 45 minutes, about 30 minutes and about 60 minutes, about 45 minutes and 75 minutes, about 60 minutes and about 90 minutes, about 75 minutes and about 105 minutes, about 90 minutes and about 120 minutes, about 105 minutes and about 135 minutes, about 120 minutes and about 150 minutes, about 135 minutes and about 165 minutes, about 150 minutes and about 180, about 165 minutes and about 195 minutes, about 180 minutes and about 210 minutes, about 195 minutes and about 225 minutes, about 210 minutes and about 240 minutes, about 225 minutes and about 255 minutes, about 240 minutes and about 270 minutes, about 255 minutes and about 285 minutes, about 270 minutes and about 300 minutes, about 285 minutes and about 315 minutes, about 300 minute and about 330 minutes, about 315 minutes and about 345 minutes, about 330 minutes and about 360 minutes, about 345 minutes and about 375 minutes, about 360 minutes and about 390 minutes, about 375 minutes and about 405 minutes, about 390 minutes and about 420 minutes, about 405 minutes and about 435 minutes, about 420 minutes and about 450 minutes, about 435 minutes and about 465 minutes, and about 450 minutes and about 480 minutes.

7. The structure for killing insects of claim 5, further comprising a timer which allows selection of said period of time, said heater operably responsive to said timer to maintain said period of time within said range.

8. The structure for killing insects of claim 5, further comprising a thermometer having temperature sensor locatable inside of said flexible enclosure and a viewable temperature indictor locatable outside of said flexible enclosure.

9. The structure for killing insects of claim 8, further comprising a temperature selector which allows selection of said temperature within said range, said heater operably responsive to said temperature selector to maintain said temperature within said range.

10. The structure for killing insects of claim 5, said flexible enclosure having an external surface and an internal surface, said internal surface sufficiently smooth to prevent egress of said insects through said releasably sealable opening.

11. The structure for killing insects of claim 5, further comprising a framework having a location inside of said flexible enclosure.

12. The structure for killing insects of claim 5, further comprising an amount of heat treatable material located within said flexible enclosure.

13. The structure for killing insects of claim 12, wherein said amount of heat treatable material has an infestation of insects.

14. The structure for killing insects of claim 13, wherein said insects are selected from the group consisting of: bed bugs, powder post beetles, moths, roaches, termites, fleas, wasps, bees, cicadas, ants, lice, head lice, mites, grain beetles, flour beetles, fire ants, mosquitoes, leafhoppers, plant hoppers, ticks, and flies, or combinations thereof.

15-33. (canceled)
